(19) United States
(12) Patent Application Publication
(10) Pub. No.: US 2011/0035547 A1
(43) Pub. Date: Feb. 10, 2011

(54) Method for utilizing mirroring in a data storage system to promote improved data accessibility and improved system efficiency

(76) Inventors: Kevin Kidney, Lafayette, CO (US); Brian D. McKean, Longmont, CO (US); Ross Zwisler, Lafayette, CO (US)

Correspondence Address: LSI Corporation c/o Suiter Swantz pc llo, 14301 FNB Parkway, Suite 220, Omaha, NE, 68154, US

(21) Appl. No.: 12/462,427

(22) Filed: Aug. 4, 2009

(51) Int. Cl. G06F 12/00

(52) U.S. Cl. 711/114; 711/E12.001

(57) ABSTRACT

The present invention is a method for utilizing mirroring in a data storage system to promote improved data accessibility and improved system efficiency. The method includes establishing a first set of drives of the system in active mode and a second set of drives of the system in passive mode (ex.—a lower power mode). The method further includes writing a first portion of data to a first drive of the first drive set, and writing a copy of the first portion of data to a second drive of the first drive set. A third drive (ex.—from the second drive set), may be activated from passive mode to active mode. The method may further include writing a second copy of the first data portion to the third drive, re-establishing the third drive in passive mode, and deleting the copy of the first data portion from the second drive.

### CROSS-REFERENCE TO RELATED APPLICATIONS

The following patent application is incorporated by reference in its entirety:

| Attorney Docket No. | Express Mail No. | Filing Date | Ser. No. |
|---|---|---|---|
| LSI 09-0099 | EM 316812549 | Aug. 04, 2009 | |

Further, U.S. patent application Ser. No. 12/288,037 entitled: Power and Performance Management Using MAIDx and Adaptive Data Placement, filed Oct. 16, 2008 (pending), which is also hereby incorporated by reference in its entirety.

### FIELD OF THE INVENTION

The present invention relates to the field of data management via data storage systems and particularly to a system and method for utilizing mirroring in a data storage system to promote improved data accessibility and improved system efficiency.

### BACKGROUND OF THE INVENTION

Currently available data storage systems/methods for providing data management in data storage systems may not provide a desired level of performance.

Therefore, it may be desirable to provide a data storage system/method(s) for providing data management in a data storage system which addresses the above-referenced shortcomings of currently available solutions.

### SUMMARY OF THE INVENTION

Accordingly, an embodiment of the present invention is directed to a method for utilizing mirroring in a data storage system to promote improved data accessibility and improved system efficiency, comprising: establishing a first set of drives of the system in active mode; establishing a second set of drives of the system in passive mode, passive mode being a lower power mode than active mode; writing a first portion of data to a first drive, the first drive being included in the first set of drives; writing a copy of the first portion of data to a second drive, the second drive being included in the first set of drives; updating metadata of the system to indicate that the copy of the first portion of data is located on the second drive; activating a third drive, the third drive being included in the second set of drives, the third drive being activated from passive mode to active mode; writing a second copy of the first portion of data to the third drive; re-establishing the third drive in passive mode; updating the metadata of the system to indicate that the second copy of the first portion of data is located on the third drive; deleting the copy of the first portion of data from the second drive; and when the first drive fails, re-activating the third drive from passive mode into active mode to allow for host access to the second copy of the first portion of data.

A further embodiment of the present invention is directed to a computer-readable medium having computer-executable instructions for performing a method for utilizing mirroring in a data storage system to promote improved data accessibility and improved system efficiency, comprising: establishing a first set of drives of the system in active mode; establishing a second set of drives of the system in passive mode, passive mode being a lower power mode than active mode; writing a first portion of data to a first drive, the first drive being included in the first set of drives; writing a copy of the first portion of data to a second drive, the second drive being included in the first set of drives; updating metadata of the system to indicate that the copy of the first portion of data is located on the second drive; activating a third drive, the third drive being included in the second set of drives, the third drive being activated from passive mode to active mode; writing a second copy of the first portion of data to the third drive; re-establishing the third drive in passive mode; updating the metadata of the system to indicate that the second copy of the first portion of data is located on the third drive; deleting the copy of the first portion of data from the second drive; and when the first drive fails, re-activating the third drive from passive mode into active mode to allow for host access to the second copy of the first portion of data.

A still further embodiment of the present invention is directed to a data storage system, including: a first set of drives, the first set of drives being established in active mode, a first drive included in the first set of drives being configured for storing a portion of data, a second drive included in the first set of drives being configured for storing a first copy of the portion of data; and a second set of drives, the second set of drives being established in passive mode, passive mode being a lower power mode than active mode, a first drive included in the second set of drives being configured for being activated from passive mode to active mode, when the first drive included in the second set of drives is activated from passive mode to active mode, the system is configured for writing a second copy of the portion of data to the first drive included in the second set of drives, re-establishing the first drive included in the second set of drives into passive mode, updating metadata of the system to indicate that the second copy of the portion of data is located on the first drive included in the second set of drives, deleting the first copy of the portion of data from the second drive included in the first set of drives, wherein Controlled Replication Under Scalable Hashing algorithms are implemented by the system for data mapping, wherein, when the first drive included in the first set of drives fails, the system is further configured for re-activating the third drive from passive mode to active mode to allow for host access to the second copy of the portion of data.

It is to be understood that both the foregoing general description and the following detailed description are exemplary and explanatory only and are not necessarily restrictive of the invention as claimed. The accompanying drawings, which are incorporated in and constitute a part of the specification, illustrate embodiments of the invention and together with the general description, serve to explain the principles of the invention.

### BRIEF DESCRIPTION OF THE DRAWINGS

The numerous advantages of the present invention may be better understood by those skilled in the art by reference to the accompanying figures in which:

FIG. 1 is a block diagram schematic of a data storage system in accordance with an exemplary embodiment of the present invention, the data storage system being in a first state of operation;

FIG. 2 is a block diagram schematic of the data storage system shown in FIG. 1 in accordance with an exemplary embodiment of the present invention, said data storage system being in a second state of operation;

FIG. 3 is a block diagram schematic of the data storage system shown in FIG. 1 in accordance with an exemplary embodiment of the present invention, said data storage system being in a third state (ex.—a steady state) of operation; and

FIG. 4 is a flow chart illustrating a method for data management in a data storage system in accordance with a further exemplary embodiment of the present invention.

### DETAILED DESCRIPTION OF THE INVENTION

Reference will now be made in detail to the presently preferred embodiments of the invention, examples of which are illustrated in the accompanying drawings.

Power usage in data centers is becoming an increasingly important issue. Spinning disk drives consume proportionally large amounts of data center power. Spinning disk drives also produce heat, which results in increased cooling costs for the data centers. With a number of data centers/data storage systems, drives of said systems may consume power and produce heat, even if: 1) data on said drives is not being accessed; and/or 2) said drives hold no data (ex.—hot spare drives).

Massive Array of Idle Disks (MAID) systems (such as disclosed in: The Case for Massive Arrays of Idle Disks (MAID)., Colarelli et al., Dept. of Computer Science, Univ. of Colo., Boulder, pp. 1-6, Jan. 7, 2002, which is herein incorporated by reference in its entirety) may be implemented in an attempt to address the above-referenced issues. However, MAID systems do not take into account the amount of data that has been written to the system. In a MAID system, a fixed number of both active drives and passive drives are allocated when the MAID system is initially configured. However, the allocations do not change dynamically as the MAID system fills with data. MAID systems are further disadvantageous in that certain portions of data may not be accessible without incurring a drive spin-up delay. While such a delay may be acceptable for many workloads, such as backups and archives, said delay may not be tolerable for more active systems.

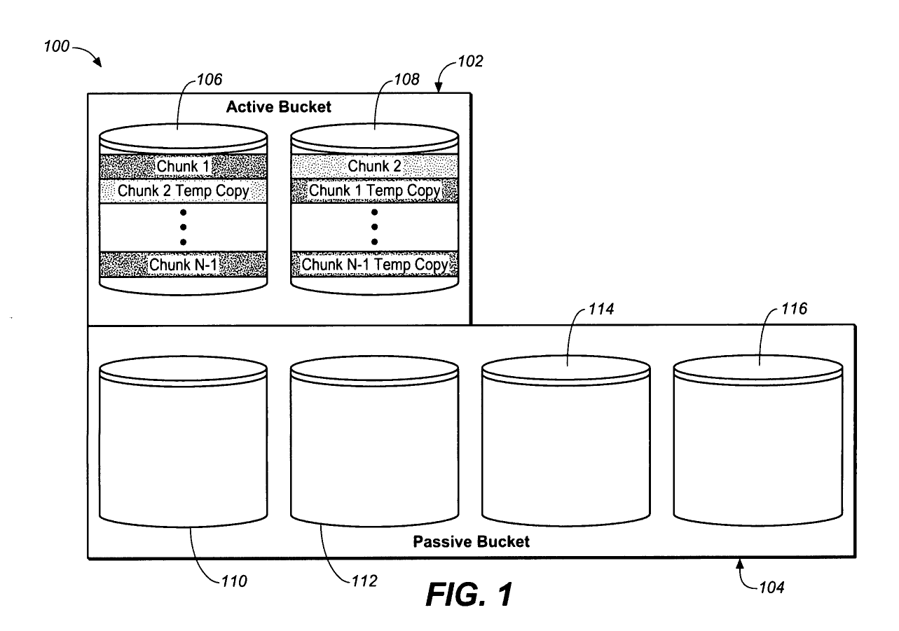

Referring to FIG. 1, a block diagram of a data storage system 100 in accordance with an exemplary embodiment of the present invention is shown. In the illustrated embodiment, the system 100 includes a first group of drives/disk drives 102 (ex.—an active bucket of drives/an active pool of drives). Each drive included in the first group of drives 102 (ex.—the active drives) operates in a first power mode (ex.—is in an active mode/is in a normal power mode/is spun-up). The system 100 further includes a second group of drives/disk drives 104 (ex.—a passive bucket of drives/passive pool of drives). Each drive included in the second group of drives 104 (ex.—the passive drives) may be configured to operate in a second power mode (ex.—a passive mode/passive power mode/low power mode/spun-down mode), the second power mode being a lower power mode than the first power mode. However, each of the passive drives 104 may be configured for being periodically (ex.—temporarily) and selectively established/moved into an active power mode (ex.—spun up) by the system 100, under certain circumstances (as will be discussed below). In further embodiments, the first group of drives 102 (ex.—the active drives) and the second group of drives 104 (ex.—the passive drives) are connected/communicatively coupled to each other. The system 100 may be configured for receiving and handling host system input/output (I/O) commands/requests, such that data may be written to and/or read from drives of the system 100.

In exemplary embodiments, the active drives 102 handle both reads and writes for the system 100. In current embodiments of the present invention, data/data segment(s) may be written to the active drive group 102, such that for each data segment (ex.—primary copy) written to/stored on a first active drive 106 included in the active drive group 102, a corresponding temporary secondary copy of the data segment may be written to and stored on a second active drive 108 included in the active drive group 102. Thus, by using unallocated space on an already active drive (as described above), host write operations do not need to activate/spin-up/switch to active mode any of the passive drives 104 in order to write both a primary copy and a temporary secondary copy of the data to the system 100. In FIG. 1, the system 100 is depicted as being at a first stage of operation, such that the system 100 has just been installed, data has been written to the active drives 102, and none of the passive drives 104 have been spun-up. For instance, in FIG. 1, a first data segment (Chunk 1) has been written to the first active drive 106 and a temporary secondary copy of the first data segment (Chunk 1 Temp Copy) has been written to the second active drive 108. Further, a second data segment (Chunk 2) has been written to the second active drive 108 and a temporary secondary copy of the second data segment (Chunk 2 Temp Copy) has been written to the first active drive 106.

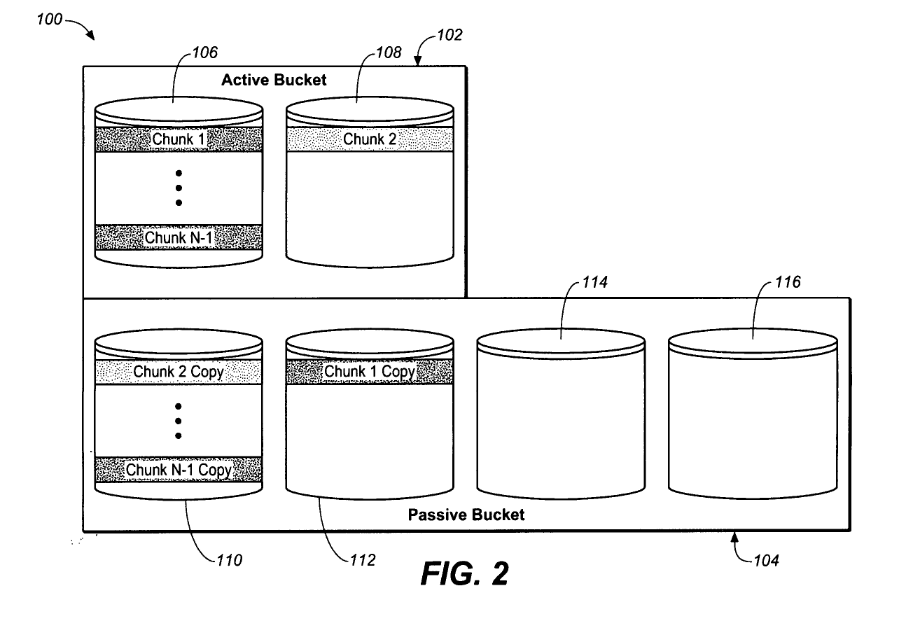

In additional embodiments, the system 100 is configured for flushing/copying the temporary secondary copy/copies of the data segment(s) from the active drive(s) 102 to the passive drive(s) 104, thereby creating a secondary copy/flushed secondary copy which is located/stored on the passive drive(s) 104. FIG. 2 depicts the system 100 at a second stage of operation, wherein the system 100 has flushed/copied the temporary copies of the active drive group 102/active bucket to the passive drive group 104/passive bucket. As shown in FIG. 2, the temporary secondary copy of the second data segment (Chunk 2 Temp Copy) has been flushed/copied from the first active drive 106 to a first passive drive 110 of the passive drive group 104, thereby creating/storing a corresponding flushed secondary copy (Chunk 2 Copy) on the first passive drive 110. Further, the temporary secondary copy of the first data segment (Chunk 1 Temp Copy) has been flushed/copied from the second active drive 108 to a second passive drive 112 of the passive drive group 104, thereby creating/storing a corresponding flushed secondary copy (Chunk 1 Copy) on the second passive drive 112. In exemplary embodiments, the passive drives (ex.—the first passive drive 110 and the second passive drive 112) may be temporarily moved/switched from passive mode to active mode in order to allow the flushed secondary copies to be written to the first passive drive 110 and the second passive drive 112. Remaining drives to which data is not being written (ex.—a third passive drive 114 and a fourth passive drive 116) of the passive drive group 104 may be maintained in passive mode/low power mode, thereby allowing the system 100 to conserve energy. Once the flushed secondary copies are written to the first passive drive 110 and the second passive drive 112, the first passive drive 110 and the second passive drive 112 may be returned/switched back to passive mode. Further, the temporary secondary copy of the first data segment (Chunk 1 Temp Copy) and the temporary secondary copy of the second data segment (Chunk 2 Temp Copy) may then be deleted from the second active drive 108 and the first active drive 106 respectively, thereby freeing up space on the first active drive 106 and the second active drive 108 to handle any new write data which may be written to the first and second active drives 106, 108. Still further, metadata of the system 100 may be updated to reflect the location of the secondary copies/flushed secondary copies (Chunk 1 Copy, Chunk 2 Copy) and to indicate that the locations on the first active drive 106 and the second active drive 108 where the temporary secondary copies/temporary copies (Chunk 1 Temp Copy, Chunk 2 Temp Copy) had been are now free/available to store new write data.

In exemplary embodiments of the present invention, the system 100 may implement mirroring (as shown in FIGS. 1-3). Mirroring is an efficient mechanism for storing the secondary copies/flushed secondary copies/secondary data on the passive drives 104 because it requires that, for a given secondary copy, only one of the passive drives of the passive drive group 104 needs to be activated/switched to active power mode/spun-up in order for that secondary copy to be written to the passive drive, thereby promoting energy conservation for the system 100. In further embodiments, the system 100 includes a number of passive drives 104 and a number of active drives 102, such that the number of passive drives 104 is equal to or greater than the number of active drives 102, thereby ensuring that data can be mirrored from the active drives/active drive group 102 to the passive drives/passive drive group 104. In the embodiment shown in FIG. 2, there are only two drives (106, 108) included in the active drive group 102, thus, because of the mirroring mechanism being implemented, only two drives (110, 112) of the passive drive group 104 are needed to hold/store secondary copies/flushed secondary copies (Chunk 1 Copy, Chunk 2 Copy) provided to the passive drives (110, 112) when the temporary secondary copies/temporary copies (Chunk 1 Temp Copy, Chunk 2 Temp Copy) are flushed/copied from the active drives (106, 108).

When the system 100 is in an optimal state (ex.—all of the drives in that active drive group 102 are functioning properly), as shown in FIG. 2, the system 100 allows a copy (primary copy) of all data stored by the system 100 to be available/located on an active drive (106, 108) at all times. For example, when the system 100 is in the optimal state, any data stored by the system 100 which is requested in a read request may be accessed from the active drive group 102 without having to activate/spin-up a drive(s) of the passive drive group 104, thereby allowing the drives of the passive group 104 to remain in passive/low power mode. This allows for ease of access to said data (ex.—such as during active workloads) without incurring a drive spin-up delay and also promotes energy efficiency (ex.—less heat is generated by the system 100 and less power is consumed by the system 100 when the system is running in optimal mode since the drives of the passive drive group 104 remain in low power mode/spun-down mode) of the system 100.

In further embodiments, as shown in FIG. 2, the system 100 of the present invention still allows for secondary data/mirrored data (ex.—backup copies (secondary copies) of all data stored by the system 100) to be available on the passive drives 104 (and thus, recoverable), in case one of the active drives 102 fails. For example, with reference to FIG. 2, if the system 100 receives a read request for the first data segment (Chunk 1)/primary copy stored on the first active disk drive 106, but the first active disk drive 106 has failed, the secondary copy (Chunk 1 Copy) may be retrieved from the passive drive group 104 (ex.—from the second passive drive 112). To allow for retrieval (ex.—reading) of the secondary copy (Chunk 1 Copy) from the second passive drive 112, the second passive drive 112 is activated/switched/spun up to normal power mode/active mode from low power mode/passive mode. This may cause a drive spin-up delay, but when the system 100 is operating in degraded mode (ex.—when an active drive 102 of the system 100 has failed), timing requirements on data access may generally be relaxed, thereby making incurrence of the delay acceptable.

In exemplary embodiments of the present invention, the system 100 may map data locations/data by implementing any method which will distribute the data uniformly among the drive set(s) (102, 104). For example, the system 100 may divide data into mirrored chunks and spread said data uniformly among/across drives in the active drive group 102 and the passive drive group 104 via implementation of Controlled Replication Under Scalable Hashing (CRUSH) algorithms which were developed by the University of California at Santa Cruz (such as disclosed in: CRUSH: Controlled, Scalable, Decentralized Placement of Replicated Data., Weil et al., Proceedings of SC '06, November 2006, which is herein incorporated by reference in its entirety).

As mentioned above, metadata is implemented in the system 100 for tracking valid copies (ex.—primary copies, temporary secondary copies, and secondary copies) of data in both the active bucket/active drive group 102 and the passive bucket/passive drive group 104. When primary data/a primary copy is overwritten in the active bucket 102 (thereby generating an updated primary copy), any corresponding secondary data/secondary copy must be either overwritten or invalidated in the metadata. In instances when the system 100 has not flushed data to the passive bucket/passive drive group 104 and a temporary secondary copy exists in the active bucket/active drive group 102 which corresponds to the primary copy, the temporary secondary copy may be overwritten at the same time its corresponding primary copy is overwritten. In instances when the system 100 has flushed data (ex.—provided a secondary copy based on a temporary secondary copy) corresponding to the primary copy to the passive bucket/passive drive group 104, the metadata may be changed to invalidate the secondary copy (which is located on a drive included in the passive drive group 104), and a new temporary secondary copy may be written to another drive in the active drive group 102 (ex.—a drive in the active drive group 102 which is a different drive than the drive on which the updated primary copy is located).

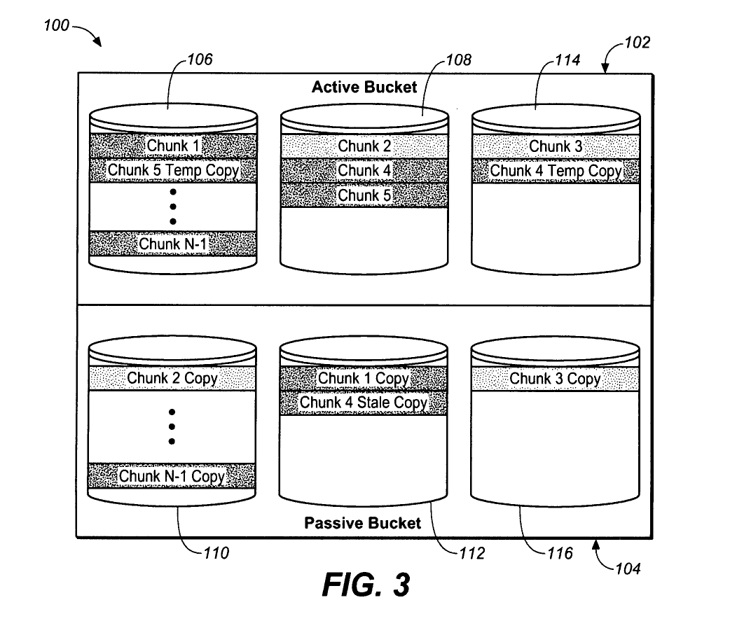

In further embodiments, the system 100 of the present invention implements Thin Provisioning, thus there may be as few as two drives included in the first group of drives/the first pool of drives/the active group of drives/the active drives 102, while the rest of the drives of the system 100 may be drives included in the second group of drives/the second pool of drives/the passive group of drives/the passive drives 104. Thus, the first group of drives 102 includes at least two drives, while the second group of drives 104 also includes at least two drives. As more active storage capacity is needed by the system 100, one or more of the passive drives 104 may be relocated from the passive bucket 104 to the active bucket 102 to become an active drive, thereby expanding the storage capacity/number of drives in the active drive group 102. Further, as the new drive(s) is/are added to the active drive group 102, the system 100 may evenly redistribute data chunks stored by the system 100, thereby keeping all active drives 102 relatively equally populated. FIG. 3 illustrates the system 100 in a third operational state (ex.—steady state operation), wherein the third passive drive 114 has been moved to the active drive group 102 to provide additional capacity in the active drive group for storing additional data (ex.—primary copy, depicted as “Chunk 3”). Further, previously unoccupied passive drive 116 has been activated/switched to active mode to allow a secondary copy corresponding to the primary copy stored on the third passive drive 114 to be written to passive drive 116. Further, the system 100, in the steady operational state shown in FIG. 3, includes a mix of temporary secondary copies, flushed secondary copies and stale secondary copies, the stale secondary copies being copies corresponding to “old” or “stale” primary copies (ex.—primary copies which have since been overwritten/updated).

In further embodiments, the system 100 of the present invention may include a third drive group/bucket, configured for implementation/connection with the active bucket 102 and/or the passive bucket 104, which may be in a completely powered off mode until needed in either the active bucket 102 or the passive bucket 104, thereby allowing the system 100 to implement drive groups in multiple, low power modes.

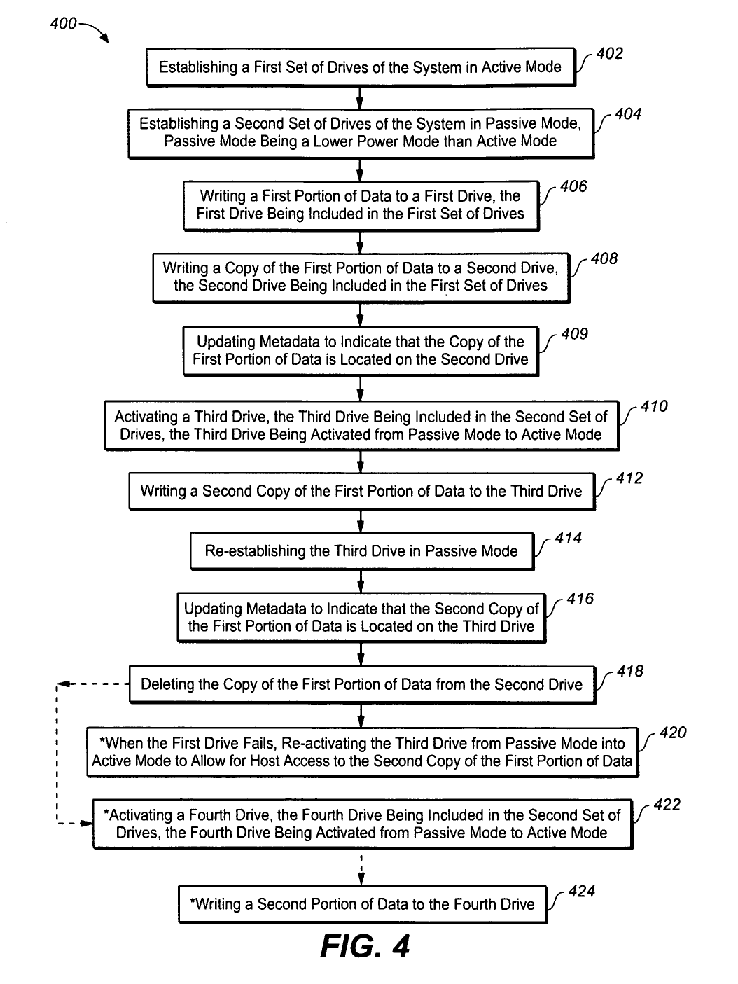

In FIG. 4, a flowchart is provided which illustrates a method for utilizing mirroring in a data storage system to promote improved data accessibility and improved system efficiency in accordance with an exemplary embodiment of the present invention. The method 400 may include establishing a first set of drives in active mode 402. The method 400 may further include establishing a second set of drives in passive mode, passive mode being a lower power mode than active mode 404. The method 400 may further include writing a first portion of data (ex.—primary copy/Chunk 1) to a first drive, the first drive being included in the first set of drives 406. The method 400 may further include writing a copy (ex.—temporary secondary copy/Chunk 1 Temp Copy) of the first portion of data to a second drive, the second drive being included in the first set of drives 408. The method 400 may further include updating metadata of the system to indicate (ex.—so that said metadata indicates) that the temporary secondary copy is located on the second drive 409. The method 400 may further include activating a third drive, the third drive being included in the second set of drives, the third drive being activated from passive mode to active mode 410. The method 400 may further include writing a second copy (ex.—secondary copy/Chunk 1 Copy) of the first portion of data to the third drive 412. The method 400 may further include re-establishing the third drive in passive mode 414. The method 400 may further include updating metadata of the system to indicate that the second copy of the first portion of data is located on the third drive 416. The method 400 may further include deleting the copy of the first portion of data from the second drive 418. When the first drive fails, the method 400 may further include re-activating the third drive from passive mode into active mode to allow for host access to the second copy of the first portion of data 420. Alternatively, in embodiments where none of the active drives 102 have failed, the system 100 may activate drive(s) from the passive drive group 104 in order to expand the storage capacity of the active drive group 102. In such embodiments, said method 400 may further include: activating a fourth drive, the fourth drive being included in the second set of drives, the fourth drive being activated from passive mode to active mode 422; and writing a second portion of data to the fourth drive 424.

It is to be noted that the foregoing described embodiments according to the present invention may be conveniently implemented using conventional general purpose digital computers programmed according to the teachings of the present specification, as will be apparent to those skilled in the computer art. Appropriate software coding may readily be prepared by skilled programmers based on the teachings of the present disclosure, as will be apparent to those skilled in the software art.

It is to be understood that the present invention may be conveniently implemented in forms of a software package. Such a software package may be a computer program product which employs a computer-readable storage medium including stored computer code which is used to program a computer to perform the disclosed function and process of the present invention. The computer-readable medium/computer-readable storage medium may include, but is not limited to, any type of conventional floppy disk, optical disk, CD-ROM, magnetic disk, hard disk drive, magneto-optical disk, ROM, RAM, EPROM, EEPROM, magnetic or optical card, or any other suitable media for storing electronic instructions.

It is understood that the specific order or hierarchy of steps in the foregoing disclosed methods are examples of exemplary approaches. Based upon design preferences, it is understood that the specific order or hierarchy of steps in the method can be rearranged while remaining within the scope of the present invention. The accompanying method claims present elements of the various steps in a sample order, and are not meant to be limited to the specific order or hierarchy presented.

It is believed that the present invention and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely an explanatory embodiment thereof, it is the intention of the following claims to encompass and include such changes.

What is claimed is:

1. A method for utilizing mirroring in a data storage system to promote improved data accessibility and improved system efficiency, comprising:
establishing a first set of drives of the system in active mode;
establishing a second set of drives of the system in passive mode, passive mode being a lower power mode than active mode;
writing a first portion of data to a first drive, the first drive being included in the first set of drives; and
writing a copy of the first portion of data to a second drive, the second drive being included in the first set of drives.

2. A method as claimed in claim 1, further comprising:
updating metadata to indicate that the copy of the first portion of data is located on the second drive; and
activating a third drive, the third drive being included in the second set of drives, the third drive being activated from passive mode to active mode.

3. A method as claimed in claim 2, further comprising:
writing a second copy of the first portion of data to the third drive.

4. A method as claimed in claim 3, further comprising:
re-establishing the third drive in passive mode.

5. A method as claimed in claim 4, further comprising:
updating the metadata to indicate that the second copy of the first portion of data is located on the third drive.

6. A method as claimed in claim 5, further comprising:
deleting the copy of the first portion of data from the second drive.

7. A method as claimed in claim 6, further comprising:
when the first drive fails, re-activating the third drive from passive mode into active mode to allow for host access to the second copy of the first portion of data.

8. A method as claimed in claim 6, further comprising:
activating a fourth drive, the fourth drive being included in the second set of drives, the fourth drive being activated from passive mode to active mode.

9. A method as claimed in claim 8, further comprising:
writing a second portion of data to the fourth drive.

10. A computer-readable medium having computer-executable instructions for performing a method for utilizing data mirroring in a data storage system to promote improved data accessibility and improved system efficiency, said method comprising:
establishing a first set of drives of the system in active mode;
establishing a second set of drives of the system in passive mode, passive mode being a lower power mode than active mode;
writing a first portion of data to a first drive, the first drive being included in the first set of drives; and
writing a copy of the first portion of data to a second drive, the second drive being included in the first set of drives.

11. A computer-readable medium as claimed in claim 10, said method further comprising:
updating metadata to indicate that the copy of the first portion of data is located on the second drive; and
activating a third drive, the third drive being included in the second set of drives, the third drive being activated from passive mode to active mode.

12. A computer-readable medium as claimed in claim 11, said method further comprising:
writing a second copy of the first portion of data to the third drive.

13. A computer-readable medium as claimed in claim 12, said method further comprising:
re-establishing the third drive in passive mode.

14. A computer-readable medium as claimed in claim 13, said method further comprising:
updating the metadata to indicate that the second copy of the first portion of data is located on the third drive.

15. A computer-readable medium as claimed in claim 14, said method further comprising:
deleting the copy of the first portion of data from the second drive.

16. A computer-readable medium as claimed in claim 15, said method further comprising:
when the first drive fails, re-activating the third drive from passive mode into active mode to allow for host access to the second copy of the first portion of data.

17. A computer-readable medium as claimed in claim 16, said method further comprising:
activating a fourth drive, the fourth drive being included in the second set of drives, the fourth drive being activated from passive mode to active mode.

18. A computer-readable medium as claimed in claim 16, said method further comprising:
writing a second portion of data to the fourth drive.

19. A data storage system, comprising:
a first set of drives, the first set of drives being established in active mode, a first drive included in the first set of drives being configured for storing a portion of data, a second drive included in the first set of drives being configured for storing a first copy of the portion of data; and
a second set of drives, the second set of drives being established in passive mode, passive mode being a lower power mode than active mode, a first drive included in the second set of drives being configured for being activated from passive mode to active mode,
when the first drive included in the second set of drives is activated from passive mode to active mode, the system is configured for writing a second copy of the portion of data to the first drive included in the second set of drives, re-establishing the first drive included in the second set of drives into passive mode, updating metadata of the system to indicate that the second copy of the portion of data is located on the first drive included in the second set of drives and deleting the first copy of the portion of data from the second drive included in the first set of drives,
wherein Controlled Replication Under Scalable Hashing algorithms are implemented by the system for data mapping.

20. A system as claimed in claim 19, wherein, when the first drive included in the first set of drives fails, the system is further configured for re-activating the third drive from passive mode to active mode to allow for host access to the second copy of the portion of data.
